(19) United States
(12) Patent Application Publication
(10) Pub. No.: US 2014/0143856 A1
(43) Pub. Date: May 22, 2014

(54) OPERATIONAL SHORTCUTS FOR COMPUTING DEVICES

(71) Applicant: Google Inc., Mountain View, CA (US)

(72) Inventors: Ronghua Wu, El Cerrito, CA (US); Qunshan Gu, Hayward, CA (US)

(73) Assignee: Google Inc., Mountain View, CA (US)

(21) Appl. No.: 13/750,628

(22) Filed: Jan. 25, 2013

Related U.S. Application Data
(60) Provisional application No. 61/728,690, filed on Nov. 20, 2012.

(51) Int. Cl. G06F 21/00

(52) U.S. Cl. CPC G06F 21/00
USPC 726/16

(57) ABSTRACT

Systems, devices, and techniques for providing shortcuts to applications of a computing device are described. In one example, a method includes outputting, for display at a screen, a plurality of input nodes while the computing device is in a locked state and receiving an indication of a selection of a set of the plurality of input nodes in a defined order. The method may also include determining that the selection matches a predetermined selection order of the input nodes, the predetermined selection order being associated with the computing device. The method may also include, responsive to the determining, outputting, for display in place of at least one of the plurality of input nodes at the screen, an icon representative of an operation executable by the computing device, receiving an indication of a selection of the icon, and responsive to receiving the indication, executing the operation.

### RELATED APPLICATION

This application claims the benefit of U.S. Provisional Application No. 61/728,690, filed Nov. 20, 2012, the entire content of which is incorporated herein by reference.

### BACKGROUND

A computing device may be configured to receive user input, via a user interface, interacting with applications executing on the computing device. For instance, a computing device may be configured to install, view, or delete an application stored at a memory of the computing device in response to user input. In some instances, a mobile computing device (e.g., mobile phone, tablet computer, smartphone, smart watch, or the like) may be used to communicate with other devices or systems. For instance, a computing device may transmit information from the mobile computing device to a remote computing device. The mobile computing device may also receive information from a remote computing device (e.g., a network server or different mobile computing device). The computing device may transmit and/or receive information directly with the remote computing device or over a network.

In some examples, a computing device may prevent access to information and/or operations of the computing device while the computing device is in a limited-access (“locked”) state. Upon receiving a request to “unlock” the computing device, the computing device may exit the locked state and enter an unlocked state. In the unlocked state, the computing device may allow the user to access information and/or operations of the computing device (e.g., interact with one or more applications executing on the computing device).

### SUMMARY

In one example, a method includes a method that includes, while a computing device is in a locked state, outputting, by the computing device and for display at a presence-sensitive screen, a plurality of input nodes; receiving, at the computing device, an indication of a selection of a set of the plurality of input nodes in a defined order; determining, by the computing device, that the selection of the set of the plurality of input nodes in the defined order matches a predetermined selection order of the plurality of input nodes, the predetermined selection order being associated with the computing device; responsive to the determining, outputting, by the computing device and for display in place of at least one of the plurality of input nodes at the presence-sensitive screen, an icon representative of an operation executable by the computing device; receiving, at the computing device, an indication of a selection of the icon; and responsive to receiving the indication of the selection of the icon, executing, by the computing device, the operation.

In another example, a computer-readable storage medium storing instructions that, when executed, cause one or more processors of a mobile computing device to perform operations including, while the mobile computing device is in a locked state, outputting, by the mobile computing device and for display at a presence-sensitive screen, a plurality of input nodes; receiving an indication of a selection of a set of the plurality of input nodes in a defined order; determining that the selection of the set of the plurality of input nodes in the defined order matches a predetermined selection order of the plurality of input nodes, the predetermined selection order being associated with the mobile computing device; responsive to the determining, outputting, by the computing device and for display in place of each of two or more of the plurality of input nodes at the presence-sensitive screen, a respective icon representative of a respective operation executable by the mobile computing device; receiving an indication of a selection of one of the respective icons; and responsive to receiving the indication of the selection of the respective icon, executing the operation.

In one example, a mobile computing device includes a user interface configured to display, while the mobile computing device is in a locked state, a plurality of input nodes and receive a continuous selection input of a set of the plurality of input nodes, the continuous selection input identifying an order of the set of input nodes; and one or more processors configured to determine that the continuous selection input of the set of the plurality of input nodes and the order of the continuous selection input matches a predetermined set and order of the plurality of input nodes, the predetermined set and order being associated with the mobile computing device, wherein the user interface is further configured to, responsive to the determination, display, in place of at least one of the plurality of input nodes, an icon representative of an operation executable by the one or more processors and receive a selection of the icon, and the one or more processors are further configured to, responsive to the selection of the icon received by the user interface, execute the operation.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system configured to display input nodes during a passcode-locked state of a computing device and icons representative of operations executable by the computing device in place of the input nodes.

FIG. 2 is a block diagram illustrating further details of one example of a computing device shown in FIG. 1.

FIG. 3A is a conceptual illustration of an example lock screen that includes input nodes displayed during a locked state.

FIG. 3B is a conceptual illustration of an example lock screen that includes a selection of a set of the input nodes shown in FIG. 3A.

FIG. 3C is a conceptual illustration of an example lock screen that displays icons representative of operations executable by a computing device in place of respective input nodes shown in FIG. 3A.

FIG. 4 is a flow diagram illustrating an example operation of a computing device that is configured to output icons representative of operations executable by the computing device in place of input nodes of a lock screen.

FIG. 5 is a flow diagram illustrating another example operation of a computing device that is configured to output icons representative of operations executable by the computing device in place of input nodes of a lock screen.

FIG. 6 is a block diagram illustrating an example computing device that outputs graphical content for display at a remote device.

### DETAILED DESCRIPTION

In general, this disclosure is directed to techniques and systems that provide shortcuts on a lock screen of a computing device to operations executable by the computing device. Typically, computing devices (e.g., mobile computing devices) may transition into a limited-access locked state configured to prevent user access to data and operations of the computing device. If a user desires to gain access to the computing device and use an operation of the computing device, the user may need to command the computing device to execute at least two steps. First, the user may need to provide an input (e.g., an authorized passcode) received by the computing device such that the computing device unlocks in response to the input. Second, the user may need to navigate through the operating system presented by the computing device before the computing device can be instructed to perform a user operation (e.g., open an application or place a phone call) or access any data.

Techniques of this disclosure may, in various instances, allow a user to access data or to enable one or more operations of the computing device without requiring the computing device to first present and navigate through the operating system. The computing device may be configured to provide one or more shortcuts to operations and/or data via a lock screen. While the computing device is in the locked state, the computing device may present a lock screen to the user. The lock screen may include a plurality of input nodes selectable in a specific order (e.g., an unlock pattern) that creates a passcode. If the unlock pattern of the selected input nodes matches a predefined pattern (e.g., an authentic passcode key) associated with the computing device, the computing device may be configured to present one or more operational shortcuts to the user via the lock screen.

For example, before exiting the lock screen upon receiving the authenticated pattern, the computing device may change one or more of the input nodes to an icon representative of an operation executable by the computing device. In other words, the input nodes may become shortcuts when the computing device replaces one or more of the input nodes with a respective icon. The computing device may position the icons in the same location as each respective input node within the lock screen. Each icon may be a visual representation of a specific operation. For example, the icons may be representative of an application (e.g., email, text message, phone call, web browser, camera, music player, mapping service, etc.) or a function (e.g., placing a phone call to a preselected contact, toggling between hardware settings, or setting an alarm). Upon selection of an icon, the computing device may exit the lock screen, exit the locked state, and perform the operation represented by the selected icon. In some examples, the computing device may have exited the locked state prior to changing the input nodes to the respective icons.

In one example, the computing device may define or generate an unlock pattern in response to user input creating the unlock pattern (e.g., an input pattern provided by swiping a finger over the input nodes in the specific order and in a continuous motion). The computing device may detect this continuous selection input in the form of a path that includes the selected input nodes. In some examples, the computing device may present the icons in place of the input nodes upon the continuous selection input selecting the last input node of the predefined pattern and before the user removes the finger from the presence-sensitive screen. Once the icons are presented on the lock screen, the computing device may receive input in the form of, for example, the user sliding the finger to the desired icon to select that icon as a part of the continuous selection input. If the user terminates the continuation selection input prior to selecting one of the icons, the computing device may exit the lock screen and present a home screen or other screen of the user interface. In other examples, the computing device may terminate the continuation selection input upon selection of the last input node in the predefined pattern. The computing device may then receive user input in the form of separate and non-contiguous selection of a desired icon that commands the computing device to perform the operation. Alternatively, the selection of input nodes may be non-contiguous. As described herein, the computing device may present icons representative of operations in place of one of one or more respective input nodes of the lock screen.

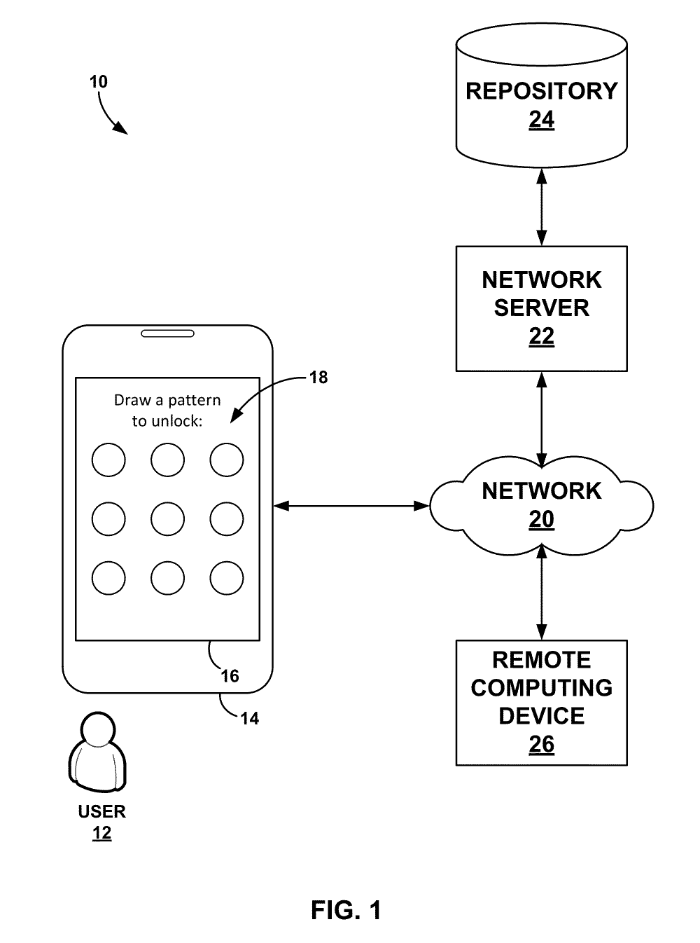

FIG. 1 is a block diagram illustrating an example system 10 configured to display input nodes 18 during a passcode-locked state of computing device 14 and icons representative of operations executable by computing device 14 in place of input nodes 18. The example system 10 of FIG. 1 includes computing device 14, network 20, network server 22, repository 24, and remote computing device 26. Computing device 14 may be associated with user 12 (e.g., user 12 may use computing device 14 for various functions or actions).

Computing devices 14, in some examples, is or may be a part of a portable or mobile computing device. A mobile computing device may include mobile phones (including smart phones), laptop computers, personal digital assistants (PDAs), portable gaming devices, portable media players, watch computing devices, tablet computers, televisions with one or more processors embedded therein or coupled thereto, and e-book readers. In other examples, computing device 14 may include or be a part of a digital camera, a music player, a navigation device, or any other computing device that may include a locked state. Although computing device 14 may generally be portable or mobile, computing device 14 may be stationary or minimally portable in other examples (e.g., a workstation or desktop computer). Computing device 14 may also connect to network 20 (e.g., a wired or wireless network). Although network 20 may be a single network, network 20 may be representative of two or more networks that allow computing device 14 to communicate with network server 22.

Computing device 14 may include user interface 16 that includes one or more input devices and/or output devices so that the user can communicate with computing devices 14. In one example, user interface 16 may be displayed at a presence-sensitive display (e.g., a touch screen interface). In some examples, user interface 16 may include a display and one or more buttons, pads, joysticks, mice, tactile device, or any other device capable of turning user actions into electrical signals that control computing device 14. In any example, the user may interact with user interface 16 to unlock computing device 14 and/or select a shortcut icon that replaces one of input nodes 18. In this manner, computing device 14 may be configured to provide icons associated with one or more functions in place of respective input nodes 18. This mechanism may allow user 12 to perform a function of computing device 14 without navigating through menus or additional screens after unlocking computing device 14.

User interface 16 may be a graphical user interface (GUI) that includes graphical elements. Example graphical elements may include a plurality of input nodes 18 presented on user interface 16 during a locked state. User interface 16 may present input nodes 18 during the locked state such that user 12 may enter a passcode via input nodes 18 to unlock computing device 14 and configured computing device 14 into an unlocked state. A predefined set of input nodes 18 may be selected by user 12 in a predefined order such that the selected order of the set of input nodes matches a predefined set and order (e.g., a predefined pattern). As described herein, upon receiving the matching selection of input nodes, computing device 14 may output function shortcuts represented as icons in place of respective input nodes 18. Computing device 14 may receive user 12 selection of one of the icons to select the represented function instead of navigating through additional menus after computing device 14 unlocks.

In addition to input nodes 18, user interface 16 may also include other graphical elements during the locked state and/or during an unlocked state. Graphical elements may include any visually perceivable object that may be displayed in user interface 16. Examples of graphical elements may include a background image, an unlock pattern, text, control buttons, input fields, icons, and/or scroll bars. User interface 16 may also be configured to present one or more lock screens during the locked state and one or more screens during the unlocked state. Although user interface 16 may include a presence-sensitive screen, for example, user interface 16 may also include one or more speakers, microphones, hard buttons, switches, or any other mechanisms for user 12 to provide or receive information to computing device 14.

Computing device 14 may be configured in a locked state and an unlocked state. In a locked state, computing device 14 may not allow any access to stored data or any functions supported by computing device 14. Although computing device 14 may present minimal information (e.g., the time of day or notifications that an email or other message has been received) on a lock screen, computing device 14 may be otherwise unusable (e.g., access to email, text messages, or phone call functionality may be prevented). The locked state may be used to prevent undesired or accidental use of or access to computing device 14.

In some examples, the locked state may be configured as a non-passcode-locked state or a passcode-locked state. In a non-passcode-locked state, computing device 14 may enter the unlocked state upon receiving a simple unlock input. The unlock input may be merely selection of a button (e.g., one or more input nodes 18) or a finger swipe across a presence-sensitive screen of computing device 14. Computing device 14 may even present textual or visual instructions to the user as to what unlock input needs to be provided to unlock the device. The unlock input may be required during the non-passcode-locked state to prevent accidental unlocking of computing device 4 while the user is carrying computing device 4, for example.

A passcode-locked state may be used to prevent unauthorized access to computing device 14 by someone other than user 12. Upon receiving an authenticated passcode (e.g., from an authorized user like user 12), computing device 14 may exit the passcode-locked state and enter the unlocked state. In the unlocked state, most or all data and functions provided by computing device 14 may be available to any user. The authenticated passcode may be a password, identification number, pattern, or gesture, as examples, that matches the passcode key associated with computing device 14. For example, the authenticated passcode may be provided to computing device 14 through user selection of a predetermined set of input nodes 18 in a predetermined order (e.g., a passcode pattern). If the passcode input provided by the user does not match a passcode key, computing device 14 does not authenticate the passcode and remains in the passcode-locked state and inaccessible to the user. Both of the passcode-locked state and non-passcode-locked state may be considered a locked state. The difference between each state may be the type of input required by computing device to exit the locked state and enter the unlocked state.

Computing device 14 may enter a locked state in response to a request from user 12 and/or after a predetermined duration of inactivity (e.g., computing device 14 receives no input from user 12 for at least a predetermined amount of time). Once computing device 14 enters the locked state, computing device 14 may maintain the locked state until computing device 14 receives an input that enables computing device 14 to exit the locked state. As described above, the required input to exit the locked state may be an unlock input or a passcode, depending upon the type of locked state of computing device 14.

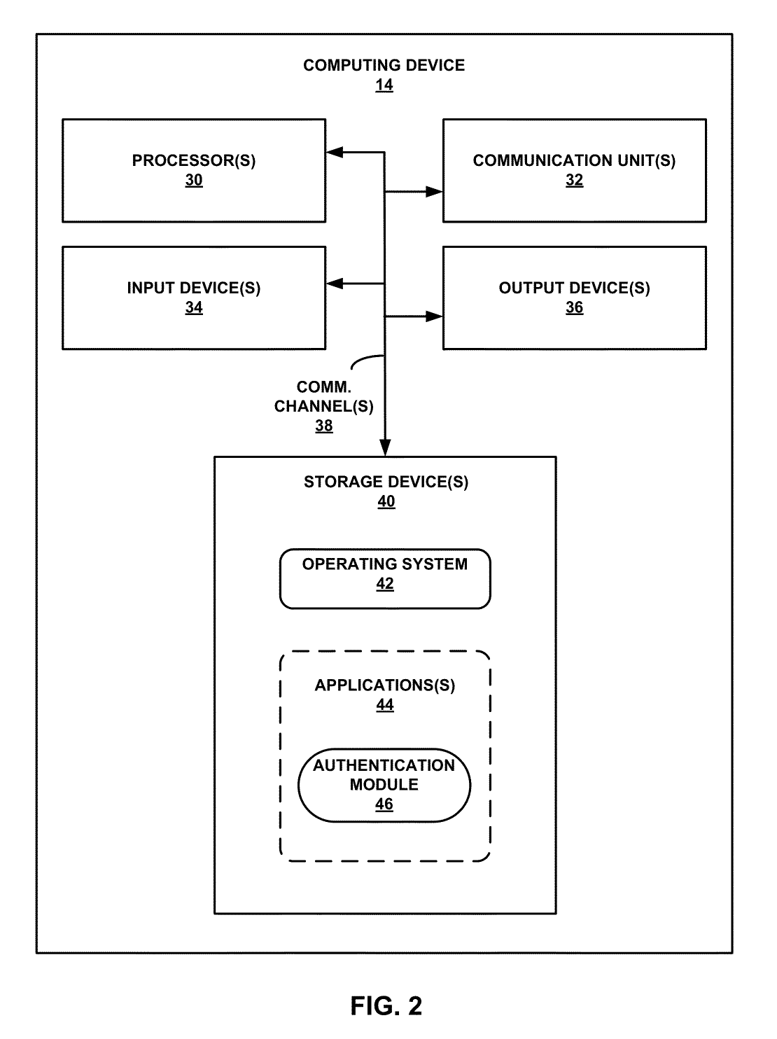

Computing device 14 may also include a communication unit (shown in FIG. 2) and other hardware that facilitates communication with network 20. As described herein, computing device 14 may be configured to transmit and/or receive data via network 20. Network 20 may be a high-speed network (e.g., a WiFi, WiMax, wireless local area network, 3G, 4G, etc.) or another wireless network (e.g., a cellular or other data network). In some examples, network 20 may be embodied as one or more of the Internet, a wired network, or a fiber optic network. In other words, network 20 may be any data communication protocol or protocols that facilitate data transfer between two or more devices.

Network server 22 may be coupled to network 20. Network server 22 may include one or more desktop computers, notebook computers, mainframes, minicomputers, or other computing devices configured to facilitate the transfer of data, executing computer instructions, and/or storing data. Network server 22 may include any hardware and software that enables network server 22 to receive data from computing device 14 or any other computing devices. Network server 26 may execute with multiple processors and/or may have functionality distributed across multiple machines. Network server 26 may also execute as a virtual machine executing on underlying hardware (which itself may be a single or multiple machines). Network server 26 may also execute as a process, or a set of processes, on a cloud server or service.

Network server 22 may be an example of one network server that receives and/or provides information for computing device 14 in support of one of more functions of computing device 14. For example, network server 22 may support phone calls from computing device 14, send and receive email data, provide updated weather information, and the like. Repository 24 may be accessible to network server 22 and provide data storage for network server 22. Repository 24 may include one or more memories, repositories, hard disks, or any other data storage device. In some examples, repository 24 may be included within network server 22.

Repository 24 may be included in, or described as, cloud storage. In other words, data accessible to computing device 14 may be stored at one or more locations in the cloud (e.g., one or more repositories 24) remote from computing device 14 and accessible via network 20 and network server 22. Network server 22 may access the cloud and retrieve or transmit data as requested by an authorized user, such as computing devices 14. In some examples, repository 24 may include Relational Database Management System (RDBMS) software. In one example, repository 24 may be a relational database and accessed using a Structured Query Language (SQL) interface that is well known in the art. Repository 24 may alternatively be stored on a separate networked computing device and accessed by network server 22 through a network interface or system bus. Repository 24 may in other examples be an Object Database Management System (ODBMS), Online Analytical Processing (OLAP) database or other suitable data management system.

To facilitate the connection with networks and access-points to the media sharing service, computing device 14 may include a short-range communication module capable of communicating with various devices. Example short-range communication devices may include Bluetooth, WiFi, near-field communication (NFC), or any other similar technology. The maximum distance between each of computing devices 14 and the other device (e.g., the vicinity or envelope surrounding each computing device 14), may be at least partially determined by the type of short-range communication used for the detection. In some instances, the maximum distance may be between approximately one meter and 100 meters. In one example, the maximum distance for the detection may be approximately 10 meters.

Remote computing device 26 may be any computing device (e.g., a mobile or stationary computing device) configured to communicate with computing device 14. For example, remote computing device 26 may be configured to receive a cellular telephone call, text message, email, or request from computing device 14 via network 20. In addition, remote computing device 26 may be configured to send any requested data to computing device 14. In this manner, a function selectable via an icon that replaces one of input icons 18 on the lock screen of user interface 16 may represent a function that includes sending data to and/or receiving data from remote computing device 26.

As described herein, computing device 14 may be configured to provide one or more shortcuts to a respective function (e.g., an application or action) in place of a respective input node 18 presented by user interface 16. In one example, computing device 14 may be configured to output, for display at a presence-sensitive screen operatively coupled to computing device 14, a plurality of input nodes 18 during a locked state of computing device 14. Computing device 14 may also be configured to receive an indication of a selection of a set of the plurality of input nodes 18. The selection of the set of input nodes 18 may also be in a defined order based on the selection. Computing device 14 may also be configured to determine that the selection of the set of the plurality of input nodes 18 and the order of the selection matches a predetermined selection and order of the plurality of input nodes 18, where the predetermined selection and order are associated with computing device 14. The predetermined selection and order may be considered a passcode or requirement for computing device 14 to exit the locked state.

Responsive to determining that the selection matches the predetermined selection of input nodes, computing device 14 may be configured to output, for display in place of at least one of the plurality of input nodes 18, an icon representative of an operation executable by computing device 14. In some examples, computing device 14 may display respective icons representative of respective operations executable by computing device 14 in place of each of two or more of input nodes 18. Each icon may function as a shortcut to a respective operation. Computing device 14 may also be configured to receive an indication of a selection of the one or more respective icons. The received indication may be a signal representative of an input provided by user 12 that selects the icon, or the indication may be a signal representative of the input user 12 provided to user interface 16 that selected the icon, for example. In response to receiving the indication of the selection of the icon, computing device 14 may be configured to execute the operation.

Input nodes 18 may be displayed on a lock screen of user interface 16 when computing device is configured in a locked state. Until a matching or authorized code is provided to computing device 14, computing device may only display the lock screen. In the example of FIG. 1, user interface 16 may present a plurality of input nodes 18, such as nine input nodes. In other examples, the number of input nodes may be fewer or greater than nine. For example, user interface 16 may present as few as two input nodes, greater than 25 input nodes, or any number in between. FIG. 1 shows that input nodes 18 are arranged in a square grid pattern. However, input nodes 18 may be arranged into any pattern. For example, input nodes 18 may be arranged into one or more triangles, rectangles, circles, or even random patterns. Although the number and spatial arrangement of input nodes 18 may be preset for computing device 14. In other examples, the number and spatial arrangement of input nodes 18 may be selectable by user 12 and stored by computing device 14.

User 12 may set or otherwise customize the predetermined set and order of input nodes 18 (e.g., a passcode pattern) that must be input to computing device 14 to change the configuration of computing device 14 from the locked state to the unlocked state. For example, computing device 14 may accept a new predetermined set and order of input nodes 18 during the unlocked state and store the predetermined set and order of input nodes in a local memory and/or at a remote storage device (e.g., repository 24) accessible via network 20. The set of input nodes 18 may include at least one or up to all of input nodes 18. The order of input nodes 18 may be the order in which user 12 selects each of the input nodes of the set. Although each input node of the set may only be selected one time during the order, one or more input nodes may be selected two or more times in the order of the selection. In this manner, the pattern created by the order of the set may include one or more input nodes multiple times.

In some examples, the selection of the set of input nodes 18 and the defined order of the selection together may include or form an input pattern. The input pattern may be the pattern formed by the sequential or consecutive selection of two or more input nodes (e.g., touch or contact of a respective input node). User interface 16 may display a line and/or arrows between each of the selected input nodes to indicate which of the input nodes have been selected and in which order each input node has been selected. The input pattern may be required to match the predetermined selection and order of input nodes 18. This predetermined selection and order of input nodes may be referred to as a pattern key. The pattern key may be associated with computing device 14. For example, the pattern key may be stored on computing device 14 and/or stored remote from and accessible to computing device 14. If the input pattern matches the pattern key, computing device 14 may exit the locked state and enter the unlocked state. In this manner, a pattern key may be an authentic passcode to which an input passcode must match to exit the locked state.

Computing device 14 may receive the indication of the set and order of input nodes 18 as a plurality of receiving the indication of the selection of a set from the plurality of input nodes may include receiving a plurality of indications, each indication representative of a selection of each respective input node 18 of the set. In other words, computing device 14 may track the selection of each input node separately and generate an order of the selections of each input node based on the order in which each indication of the input node selections is received. The selection of each input node may be made by discrete and non-contiguous inputs to user interface 16. For a presence-sensitive display, for example, user 12 may touch the display with a finger to select each input node and remove the finger from the display before touching a second input node. In other examples, a single indication received by computing device 14 may be representative of non-contiguous selections of the input nodes of the set. In other words, two or more separate inputs selecting the input nodes of the set may make up the non-contiguous selections.

Alternatively, computing device 14 may receive a single indication of a continuous selection input that coincides with each of the input nodes of the set according to the order of the selection. In other words, a continuous selection input that coincides with each of the input nodes in the set may be described as a pattern that intersects or touches each of the input nodes of the set. The continuous selection input may include, in the example of a presence-sensitive display, user 12 swiping a finger across each input node of the set and in the order required to match the predetermined set and order and unlock computing device 14. In this manner, user 12 may trace the pattern of the set and order of input nodes 18 on user interface 16 to provide the continuous selection input, and computing device 14 may be configured to receive input, or an indication of the input, in the form of the continuous selection input of input nodes 18.

If a selected set of input nodes 18 or the order of input nodes 18 does not match the predetermined set and order of input nodes required to configure computing device 14 in the unlocked state, computing device 14 may remain configured in the locked state. Non-matching inputs provided by user 12 may be indicated as such by user interface 16 with graphical, textual, tactile, and/or auditory indications of an unauthorized input. Non-matching inputs provided by user 12 may also not result in any shortcuts or icons replacing input nodes 18 because computing device 14 has not been configured into the unlocked state.

When the selected set and order of input nodes 18 matches the predefined set and order of input nodes, computing device 14 may change its configuration from the locked state to the unlocked state. In addition, prior to exiting the lock screen on which input nodes 18 are displayed, computing device 14 may display shortcuts to one or more operations in place of one or more respective input nodes. The shortcuts may be icons (e.g., graphical images or text) that represent different operations executable by at least computing device 14. In other words, upon receiving an authorized pattern via input nodes 18 on the lock screen, computing device 14 may replace one or more of input nodes 18 with respective icons of different operations, without leaving the lock screen. The replacement of input nodes 18 with different icons as a shortcut to the respective operations may prevent user 12 from needing to navigate through menus or other screens before selecting the desired operation.

In this manner, computing device 14 may, responsive to determining that the selected set and order of input nodes 18 matches a predefined set and order of input nodes (e.g., the input pattern matches the predefined pattern), computing device 14 may output, for display in place of at least one of input nodes 18, an icon representative of an operation executable by at least computing device 14. Although computing device 14 may only replace one of input nodes 18 with an icon, computing device 14 may replace two or more input nodes 18 with respective icons in other examples. In some examples, all input nodes 18 may be replaced with respective icons of different operations. Any input nodes 18 that are not replaced with an icon may remain displayed on the lock screen or removed from the lock screen.

User 12 may select one of the icons as a shortcut to cause computing device 14 to execute the desired operation. In other words, computing device 14 may directly execute an operation, without navigating through additional menus, in response to receiving an indication of a selected icon that represents the operation. The selection of the icon may be a separate and non-contiguous input from any inputs used to select the set and order of input nodes 18 during the locked state. Alternatively, the continuous selection input provided to select the set and order of input nodes 18 may also include selection of the desired icon. For example, computing device 14 may determine, during the continuous selection input, that the input has selected the set and order of input nodes 18 that match the predetermined set and order of input nodes. In response to this determination, computing device 14 may output the icons in place of the respective input nodes 18 before user 12 has completed the continuous selection input. User 12 may then complete the continuous selection input by selecting the desired icon. In this manner, computing device 14 may be configured to receive a single continuous selection input that unlocks computing device 14 and selects a shortcut to an operation executable by the computing device.

In some examples, the icons displayed in place of respective input nodes 18 may be predetermined and arranged by user 12. Computing device 14 may provide a customization menu that receives input from user 12 identifying where each icon for a respective operation will be placed within the grid, or matrix, of replaceable input nodes 18. In other examples, computing device 14 may automatically select a static arrangement of the most frequently used, most recently used, or default icons and operations. Alternatively, computing device 14 may dynamically determine which icons will replace input nodes and/or where each icon will be arranged on the lock screen. For example, computing device 14 may identify the most frequently used or the most recently used operations to replace respective input nodes 18. In some examples, computing device 14 may even employ an algorithm that incorporates both most frequently used and most recently used operations to predict the most relevant operations for the user. Computing device 14 may then replace at least some of input nodes 18 with respective operations that have been dynamically determined based on the usage of operations executable by computing device 14.

In other examples, the location of each icon (e.g., which input node 18 the respective icon replaces) may be dynamically determined based on the last input node of the selected order of input nodes (e.g., the last input node of the unlock pattern). In other words, certain icons may be selected to replace respective input nodes 18 closer to the end of the unlock pattern—where the finger of the user would be if the user interface included a presence-sensitive screen. For example, computing device 14 may be configured to prioritize a plurality of operations executable by computing device 14 based on a frequency with which each of the plurality of operations have been executed by computing device 14. Higher priority operations may be those operations used more frequently. Computing device 14 may then determine the last input node 18 of the order of the pattern and output, based on the prioritizing and for display in place of input nodes 18, icons representative of more frequently executed operations closer to the last input node than icons representative of less frequently executed operations. In this manner, computing device 14 may dynamically determine which icons of operations should be located in close proximity to the last input node of the unlock pattern. This technique may also be used to position icons based on the most recently used operations, most popular operations based on data from other users, or any other prioritizing criteria. This prioritizing of icon location may reduce the amount of time for the user to find a desired icon and move to select the found icon.

The operations represented by respective icons may be any function executable by computing device 14 and/or another remote computing device. For example, an operation may include launching an application (e.g., a software application), configuring a setting of computing device 14, transmitting data to a remote computing device, and establishing a communication channel with the remote computing device. Each of these operations may be represented by a default icon associated with the operation or an icon selected by the user to be associated with the operation. In some examples, the operation may be a custom operation selected by the user (e.g., a single operation to place a phone call to a specific contact).

Example applications may include a web browser, a mapping application, a camera application, an email application, a calculator, a music player, a weather application, a text message application, or any other software application or module executable by computing device 14 and/or another computing device to perform a function. Launching an application may include opening a previously closed application or presenting an application that is already executing in the background to the user. Configuring a setting of computing device 14 may include functions such as changing a display brightness, changing an audio volume, or enabling or disabling a network connection such as WiFi. Establishing a communication channel with a remote computing device (e.g., another mobile computing device) may be performed for an operation that may include a voice phone call, video conference call, text chat, or any type of real-time communication session. The communication channel may be established over one or more networks via one or more network servers.

During the passcode-locked state, user interface 16 may present a passcode field that includes input nodes 18 on the lock screen of computing device 14. Input nodes 18 of the passcode field may be an input mechanism that a user may use to provide an authenticated passcode to computing device 14 for exiting the locked state. The authenticated passcode may match an authentic passcode or pattern key associated with computing device 14. Computing device 14 may thus receive, via input nodes 18 of the lock screen, an authenticated passcode. Responsive to receiving the authenticated passcode, computing device 14 may enable or enter an unlocked state of computing device 14. Entering of the unlocked state may also include exiting of the locked state (which may be a passcode-locked state).

The passcodes described herein for exiting the locked state are generally described as graphical patterns or orders of input nodes. However, in other examples, selective input fields may be used to select or enter numbers, characters, letters, or any other symbols that may be used to create a passcode. In this manner, a passcode may also be a numerical code, an alphabetical code, an alphanumeric code, or a biometric. Upon entry of an authenticated passcode to exit the locked state, the icons described herein may also be used to replace these selective input fields and allow selection of one or more operations prior to leaving the lock screen of computing device 14.

Various aspects of the disclosure may be operable only when the user has explicitly enabled such functionality. For example, in the instance where the user has consented to the use of any data collected with respect to previous execution of operations, the data may be used to customize icons or otherwise determine various options related to short-cuts on the lock screen or unlocking the computing device. The user may consent or revoke consent to the collection or transmission of any data at any time. In addition, various aspects of the disclosure may be disabled by the user. Thus, a user may elect to prevent computing device 14 from presenting icons that represent one or more types of operations prior to leaving the lock screen. Computing device 14 may present one or more screens requesting that the user elect to transmit any or all information. In this manner, the user may control what information, if any, is transmitted to server device 26 and/or computing devices 34. More generally, privacy controls may be applied to all aspects of the disclosure based on a user's privacy preferences related to the use of computing device 14 or any other computing device described in this disclosure.

FIG. 2 is a block diagram illustrating further details of one example of computing device 14 of FIG. 1. FIG. 2 illustrates only one particular example of computing device 14, and many other examples of computing device 14 may be used in other instances. As shown in the specific example of FIG. 2, computing device 14 includes one or more processors 30, one or more communication units 32, one or more storage devices 40, one or more input devices 34, and one or more output devices 36. Computing device 14 may also include an operating system 42 that is executable by computing device 14. Computing device 14, in one example, further includes authentication module 46 that may be one of applications 44 executable by computing device 14. Each of components 30, 32, 34, 36, 40, and 44, for example, may be interconnected (physically, communicatively, and/or operatively) for inter-component communications. In some examples, communication channels 38 may include a system bus, network connection, interprocess communication data structure, or any other channel for communicating data. As one example in FIG. 2, components 30, 32, 34, 36 and 40 may be coupled by one or more communication channels 38.

Processors 30, in one example, are configured to implement functionality and/or process instructions for execution within computing device 14. For example, processors 30 may be capable of processing instructions stored in storage device 40. In some examples, one or more processors 30 may offload one or more processes to be computed at a networked server (e.g., server device 26) or another remote computing device.

One or more storage devices 40, in one example, are configured to store information within computing device 14 during operation. Storage device 40, in some examples, is described as a computer-readable storage medium. In some examples, storage device 40 is a temporary memory, meaning that a primary purpose of storage device 40 is not long-term storage. Storage device 40, in some examples, is described as a volatile memory, meaning that storage device 40 does not maintain stored contents when the computer is turned off. Examples of volatile memories include random access memories (RAM), dynamic random access memories (DRAM), static random access memories (SRAM), and other forms of volatile memories known in the art. In some examples, storage device 40 is used to store program instructions for execution by processors 30. Storage device 40, in one example, is used by software or applications running on computing device 14 (e.g., applications 44) to temporarily store information during program execution.

Storage devices 40, in some examples, also include one or more computer-readable storage media. Storage devices 40 may be configured to store larger amounts of information than volatile memory. Storage devices 40 may further be configured for long-term storage of information. Storage devices 40 may store instructions for replacing input nodes with icons representative of operations executable by computing device 14. Storage devices 40 may also store applications or other software representative of the executable operations. In some examples, storage devices 40 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 14, in some examples, also includes a communication unit 32. Computing device 14, in one example, utilizes communication unit 32 to communicate with external devices via one or more networks, such as one or more wireless networks. Communication unit 32 may be a network interface card, such as an Ethernet card, an optical transceiver, a radio frequency transceiver, or any other type of device that can send and receive information. Other examples of such network interfaces may include Bluetooth®, 3G and WiFi® radios in mobile computing devices as well as USB. In some examples, computing device 14 may utilize communication unit 32 to wirelessly communicate with an external device such as network server 22 and remote computing device 26 of FIG. 1, a mobile phone, or other networked computing device.

Computing device 14, in one example, also includes one or more input devices 34. Input device 34, in some examples, is configured to receive input from a user through tactile, audio, or video feedback. Examples of input device 34 include a presence-sensitive screen, a mouse, a keyboard, a voice responsive system, video camera, microphone and/or any other type of device for detecting a command or request from a user. In some examples, a presence-sensitive screen may include a touch-sensitive screen.

One or more output devices 36 may also be included in computing device 14. Output device 36, in some examples, is configured to provide output to a user using tactile, audio, or video stimuli. Output device 36, in one example, includes a presence-sensitive screen, a sound card, a video graphics adapter card, or any other type of device for converting a signal into an appropriate form understandable to humans or machines. Additional examples of output device 34 include a speaker, a liquid crystal display (LCD), an organic light-emitting diode display (OLED), or any other type of device that can generate intelligible output to a user. In some examples, one or more devices may include functions of input device 34 and output device 36 (e.g., a presence-sensitive screen).

Computing device 14 may include operating system 42. Operating system 42, in some examples, controls the operation of components of computing device 14. For example, operating system 42, in one example, controls transition between locked states and unlocked states of computing device 14. Operating system 42 may also control the creation of authenticated passcodes (e.g., graphical patterns of input nodes such as a pattern key), the determination of when a received passcode matches a predetermined passcode (e.g., a pattern key), and/or how operations replace input nodes on a lock screen. Alternatively, one or more of these functions may be controlled by one or more applications 44.

In accordance with aspects of the present disclosure, processors 30 may configure computing device 14 into a locked state, such as a passcode-locked state to protect computing device 14 from unauthorized use. Storage devices 40 may store a copy of the authorized passcode that must be matched before processors 30 may exit the passcode-locked state and present icon short-cuts representative of respective operations. Storage devices 40 may store preferences from the user that define how and when processors 30 replace input nodes with icons on the lock screen. Storage devices 40 may also store which icons are representative of which operations and any default or user defined operations selectable on the lock screen. For example, if an icon is selected that is representative of an operation requiring the establishment of a video conference, processors 30 may configure communication unit 32 to establish the communication channel needed for the video conference between computing device 14 and another remote computing device 26, for example.

Output device 36 may present a lock screen during a locked state of computing device 14. Processors 30 may cause output devices 36 to present the lock screen in response to receiving an input from a user to activate computing device 14 (e.g., an input that requests computing device 14 exit a sleep state, enable a display, or otherwise interact with computing device 14). Input devices 34 may receive a passcode input from the user to exit the locked state of computing device 14. Output device 36 may then present one or more icons representing respective operations in place of one or more input nodes used to input the passcode. In some examples, authentication module 46 may control the creation of passcodes (e.g., a graphical pattern using input nodes) and/or the authentication of passcode input from a user to a stored authentic, or predefined, passcode. Although the authentic passcode may be stored in storage device 40 or another storage device of computing device 14, authentic passcodes may alternatively be stored in a remote computing device such as network server 22 or remote computing device 26.

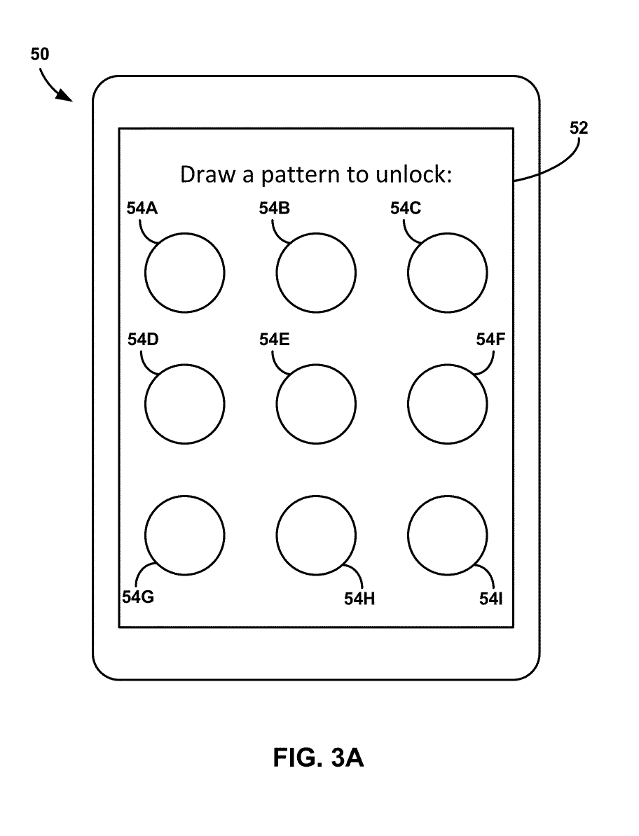

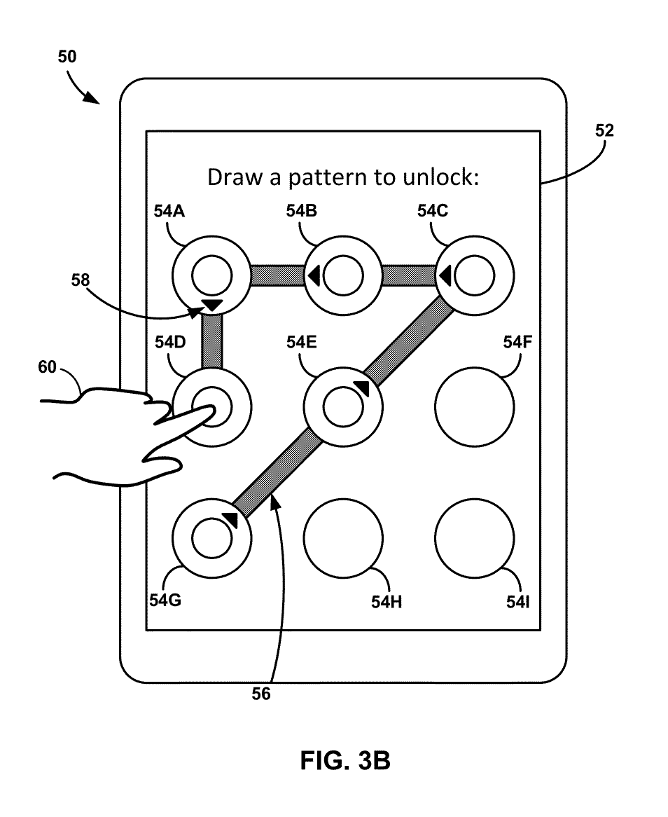

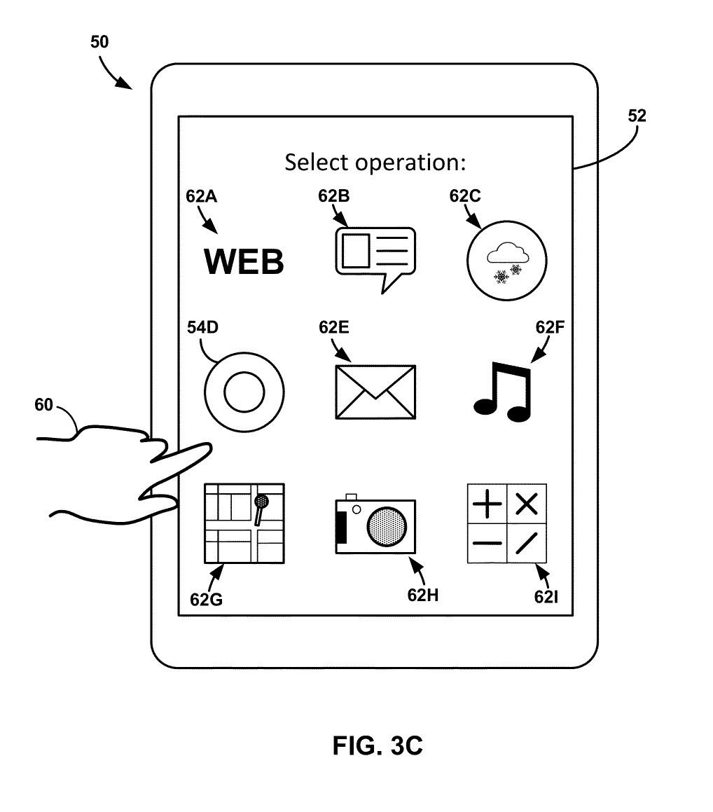

FIGS. 3A, 3B, and 3C illustrate example configurations of a lock screen with input nodes and icons that can be used to replace respective input nodes upon receiving an authenticated passcode. FIG. 3A is a conceptual illustration of an example lock screen 52 that includes input nodes 54A-I (collectively “input nodes 54”) displayed during a locked state. As shown in FIG. 3A, computing device 50 presents lock screen 52 during a locked stated of computing device 50. Computing device 50 may be an example of computing device 14, and lock screen 52 may be presented by a user interface such as user interface 16 of FIG. 1. Lock screen 52 may include input nodes 54 arranged on lock screen 52. Input nodes 54 may be examples of input nodes 18 of FIG. 1.

Computing device 50 may present lock screen 52 when computing device 50 is configured in a locked state and computing device 50 determines that a user may desire to exit the locked state. Computing device 50 may previously have entered the locked state upon receiving a request from a user to enter the locked state or upon a period of time in which computing device 50 has not received any input or otherwise has been idle. When the user attempts to access computing device 50 during the locked state, computing device 50 may present lock screen 52 until an authorized passcode is received by computing device 50 via lock screen 52. Example attempts to access computing device 50 may include selecting a hard button such as a power button on computing device 50 or detected interaction with a presence-sensitive screen of computing device 50. In some examples, lock screen 52 may include instructions for entering the passcode, such as “Draw a pattern to unlock:”.

Lock screen 52 may be configured to receive input from the user, such as user 12 of FIG. 1, via input nodes 54. Input nodes 54 may be presented in a prearranged array or geometric pattern on lock screen 52. Although nine input nodes 54 are shown in a three-by-three square pattern, different numbers of input nodes and/or different arrays of input nodes may be presented in other examples. In another example, input nodes may be arranged in a circular array around the edges of lock screen 52. In other examples, input nodes may be arranged in diagonal rows and columns. In any case, input nodes 54 may be provided in any default, predetermined, or user selected arrangement and number of input nodes. If a new arrangement of input nodes is selected, the user may be required to enter a new authentic passcode for the new arrangement of input nodes.

Input nodes 54 are shown as circles in the example of FIG. 3A. However, input nodes 54 may alternatively be presented as other shapes such as squares, triangles, stars, or amorphous shapes. In other examples, input nodes 54 may not be shown on lock screen 52. Instead, based on the user's memory or locations within a background image of lock screen 52, the user may select the appropriate input nodes 54 without a graphical representation of the location of each input node. In other words, the user may still select the input nodes hidden in lock screen 52.

Each of input nodes 54 may be selected by a user to match the authentic passcode (e.g., a pattern key associated with computing device 50) to exit the locked state. The correct input nodes (e.g., a set of input nodes 54) are selected in the same order as the set of input nodes stored as the authentic passcode. If the same individual input nodes 54 are selected in the same order of the authentic passcode, then computing device 50 may authenticate the input passcode and exit the locked state. If the selected input nodes 54 do not include the exact set of input nodes of the authentic passcode and/or the exact order of input nodes of the authentic passcode, then computing device 50 may continue to present lock screen 52. Computing device 50 may again accept another attempt at the authentic passcode. In some examples, computing device 50 may lock out the user from further passcode attempts if a predetermined number of attempts are unsuccessful.

FIG. 3B is a conceptual illustration of example lock screen 52 that includes a selection of a set of input nodes 52 shown in FIG. 3A. As shown in FIG. 3B, computing device 50 has defined input pattern 56 using received input from user 12 creating input pattern 56 through the successive selection of different input nodes 54 using finger 60. Pattern 56 has been created by selecting a set of input nodes 54 in the order of input nodes 54G, 54E, 54C, 54B, 54A, and 54D. In example pattern 56, the set of input nodes 54 includes input nodes 54G, 54E, 54C, 54B, 54A, and 54D. Finger 60 may be slid across or over each of input nodes 54G, 54E, 54C, 54B, 54A, and 54D without lifting finger 60 from the screen of computing device 50 (e.g., a continuous selection). In other examples, input nodes 54 may be selected by lifting and pressing each of the desired input nodes 54 in the order intended to match the authentic passcode (e.g., a non-contiguous selection). In some examples, a combination of continuous and non-contiguous selections may be used to create pattern 56.

Once an input node 54 is selected as part of pattern 56, computing device 50 may highlight or otherwise change a visual aspect of the selected input node to indicate that the input node has been selected. The changed visual aspect may be additional shapes, colors, or even animations. The direction in which pattern 56 coincides with (e.g., intersects) each of input nodes 54 may be indicated by arrow 58. Each of input nodes 54 may include a respective arrow 58. Arrow 58 may indicate the order of each of the selected input nodes 54. Pattern 56 may include a line or path shown between each of the selected input nodes 54. In other examples, only input nodes 54 may be highlighted within any visual marking between each selected input nodes. In other examples, the visual marking of pattern 56 may be graphically provided on lock screen 52 without any changes to selected input nodes.

Computing device 50 may compare pattern 56 to a stored authentic passcode. Computing device 50 may continually compare the selected input nodes 54 and order of the input nodes until the set and order of the selected input nodes 54 matches the predetermined selection and order of the stored passcode. Upon a match being made, computing device 50 may replace input nodes 54 with icons as described in FIG. 3B and exit the locked state. In other examples, computing device 50 may wait to compare pattern 56 until the pattern is complete. For example, finger 60 must be lifted from the screen of computing device 50 to indicate the pattern 56, or entered passcode, has been completed. If pattern 56 matches the authentic passcode, or pattern key associated with computing device 50, then computing device 50 may replace the input nodes with icons and exit the locked state.

Pattern 56 is just one example of a possible passcode that may be entered by a user. An authentic passcode may include any number of input nodes 54 and in any order. In some examples, one or more of input nodes 54 may be used more than once. In this manner, pattern 56 may create crosses within the array of input nodes 54. If pattern 56 matches the order and set of input nodes 54 of the authentic passcode, computing device 50 may exit the locked state and present one or more icons in place of respective input nodes 54, as shown in FIG. 3C.

FIG. 3C is a conceptual illustration of example lock screen 52 that displays icons 62A-I (collectively “icons 62”) representative of operations executable by computing device 50 in place of respective input nodes 54 shown in FIGS. 3A and 3B. As shown in FIG. 3C, computing device 50 has replaced most of input nodes 54 with respective icons 62 in response to determining that the selected set and order of input nodes 54 matched a predetermined pattern key, i.e., the input pattern was authenticated. Each of icons 62 may be described as a “short-cut” in some examples, e.g., selectable icons that represent respective operations executable by computing device 50.

In the example of FIG. 3C, finger 60 was removed from input node 54D on the screen to complete the input of pattern 56 of FIG. 3B. However, in other examples, removal of finger 60 from the screen may not be necessary. Since pattern 56 was authentic, computing device 50 has exited the locked state and presented icons 62 in place of respective input nodes 54 on lock screen 52. For example, icon 62A has replaced 54A and icon 62B has replaced 54B. Input node 54D may not be replaced by an icon to reduce the inadvertent selection of an icon at that input node because finger 60 may be located in that region of lock screen 52 immediately after completing the pattern 56. In other examples, computing device 50 may replace input node 54D with an icon even if input node 54D was the last input node selected for the pattern.

In some examples, finger 60 may be lifted from the last input node 54D prior to icons 62 replacing their respective input nodes. Computing device 50 may detect the removal of finger 60 and subsequently receive input of user 12 touching of the area of the screen proximate to (e.g., in close proximity or directly over) a desired icon to select that icon. This type of selection of an icon may be described as non-contiguous. In other examples, icons 62 may immediately replace respective input nodes 54 after pattern 56 is determined to be authentic and without finger 60 being removed from input node 54D. Finger 60 may then move directly to a desired icon in a continuous selection. Alternatively, finger 60 may be removed from input node 54D and then used to select a desired icon in a non-contiguous manner. Once an icon 62 has been selected, computing device 14 may execute the represented operation and exit lock screen 52. If computing device 14 is not yet configured in an unlocked state, computing device 14 may exit the locked state and enter the unlocked state in response to receiving the selection of an icon 62.

Icons 62 provided in FIG. 3C are only some examples of icons that may be used to represent operations executable by computing device 14. Icon 62A may be used to represent launching a web browser, icon 62B may be used to represent entering a text message application, icon 62C may represent launching of a weather application, and icon 62E may represent launching of an email application. In addition, icon 62F may represent a music player application, icon 62G may represent a mapping application, icon 62H may represent a camera application, and icon 621 may represent a calculator application. Icons 62 may include any type of textual or graphical icon that represents any type of operation. In other examples, one or more icons 62 may represent a particular menu or group of applications to which computing device 50 may navigate upon selection of that particular icon.

In some examples, user 12 may not desire to use any of the short-cuts represented by icons 62. In other words, user 12 may desire to enter a main screen or main menu of computing device 50 directly from lock screen 52. For example, when pattern 56 is received via a continuous selection input selecting input nodes 56, simply removing finger 60 from exit lock screen 52 may cause computing device 50 to enter a main screen or other menu or default application of computing device 50. In another example, computing device 50 may receive input of user 12 selecting input node 54D or a separate menu button (not shown) to exit lock screen 52 without selecting a specific operation. In additional examples, computing device 50 may employ a time out or elapsed period of time without any input to leave lock screen 52 and enter a home screen of computing device 50. For example, the time out period may be generally between one second and 10 seconds. However, shorter or longer time out periods may be used in other examples. Alternatively, user 12 may swipe one, two, or more fingers across the screen to exit lock screen 52 and enter another menu or home screen. In some examples, the swipe may slide lock screen 52 and icons 62 off of the display screen.

In alterative examples, icons 62 may not replace the respective input nodes 54. Instead, computing device 50 may associate one or more of input nodes 54 with respective operations executable by computing device 50 such that selection of an input node after pattern 56 is authenticated commands computing device 14 to execute the operation associated with the selected input node. In this manner, user 12 may still have access to operation shortcuts via exit lock screen 52 without separate identifying icons 62. However, without visual differentiation between input nodes 54, user 12 may need to remember which operations as associated with each of input nodes 54. In some examples, input nodes 54 may change color or provide some other indication that the input nodes have changed and available for selection as a shortcut to a respective operation.

Although FIGS. 3B and 3C are described with respect to a finger 60 touching a presence-sensitive screen, similar features may be used with different input methods. For example, a stylus may be used to interact with the user interface of computing device 50. Alternatively, a mouse or other pointing device may be used to select input nodes and icons.

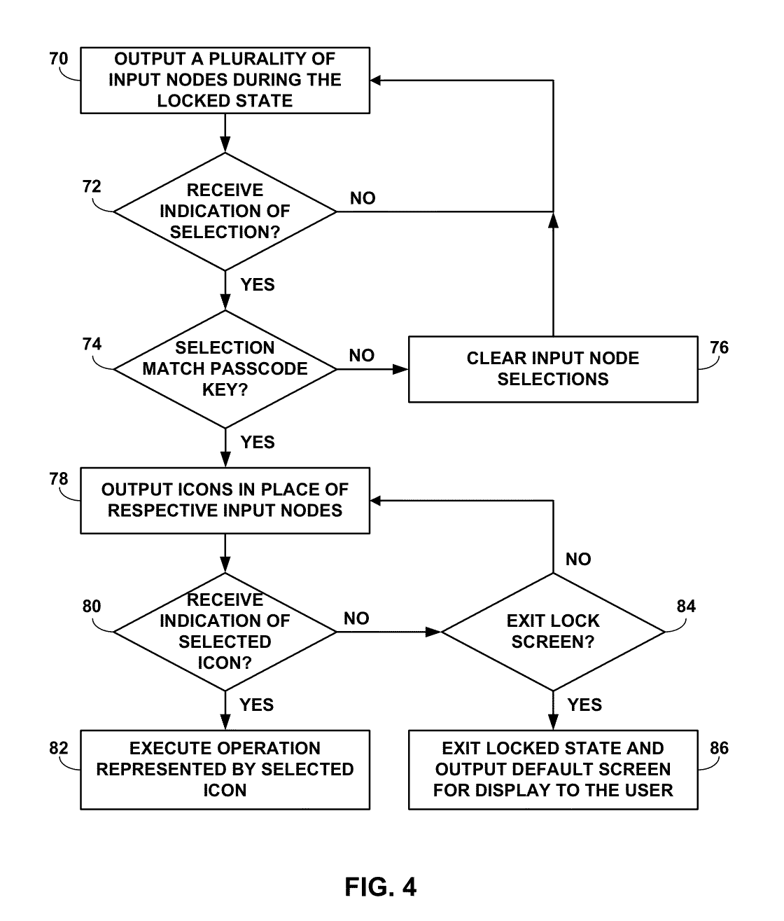

FIG. 4 is a flow diagram illustrating an example operation of computing device 14 for outputting icons representative of operations executable by computing device 14 in place of input nodes of a lock screen. For purposes of illustration only, computing device 50 of FIGS. 3A, 3B, and 4C will be described for the process of FIG. 4. Since computing device 50 may be an example of computing device 14, computing device 50 will be described as including processor 30 of FIG. 2.

As shown in FIG. 4, processor 30 may output a plurality of input nodes 54 during a locked state of computing device 50 (70). If processor 30 does not receive any indication of a selection of input nodes 54 (“NO” branch of block 72), processor 30 may continue to output the input nodes on lock screen 52 (70). If processor 30 receives an indication of a selection of input nodes 54 (“YES” branch of block 72), processor 30 may check to see if the selection matches a predetermined passcode. If the indicated selection of input nodes matches the set and order of input nodes of the passcode key (e.g., authentic passcode) (“YES” branch of block 74), processor 30 may output icons 62 in place of the respective input nodes 54 (78). If the indicated selection input nodes does not match the predetermined passcode (“NO” branch of block 74), processor 30 may clear the input node selections (76) and continue to output the input nodes 54 via the lock screen 52.

Once computing device 14 presents icons 62 (78), processor 30 determines if any icon has been selected. If processor 30 does not receive an indication of a selected icon (“NO” branch of block 80), processor 30 checks to determine if any input or other command requests processor 30 to exit lock screen 52 (84). If processor 84 is not to exit the lock screen (“NO” branch of block 84), processor 30 may continue to output icons 62 (78). If processor 30 receives an input or command to exit lock screen 54 (“YES” branch of block 84), the processor 30 exits the locked state and outputs the default screen or menu for display to the user (86). In some examples, processor 30 may have exited the locked state prior to presenting icons 62 on lock screen 52. If processor 30 receives an indication of a selected icon (“YES” branch of block 80), processor 30 may execute the operation represented by the selected icon 62 and exit lock screen 52 (82).

In other examples, the process of FIG. 4 may include more or fewer steps. For example, processor 30 may dynamically determine which icons to present and/or which icons will replace which input nodes prior to outputting icons 62. In addition, the process of FIG. 4 may be used with continuous and non-contiguous selections of input nodes and/or icons. In any case, processor 30 may replace one or more input nodes 54 with a respective icon such that lock screen 52 may be used to present short-cuts to certain operations after an authentic passcode is received from the user.

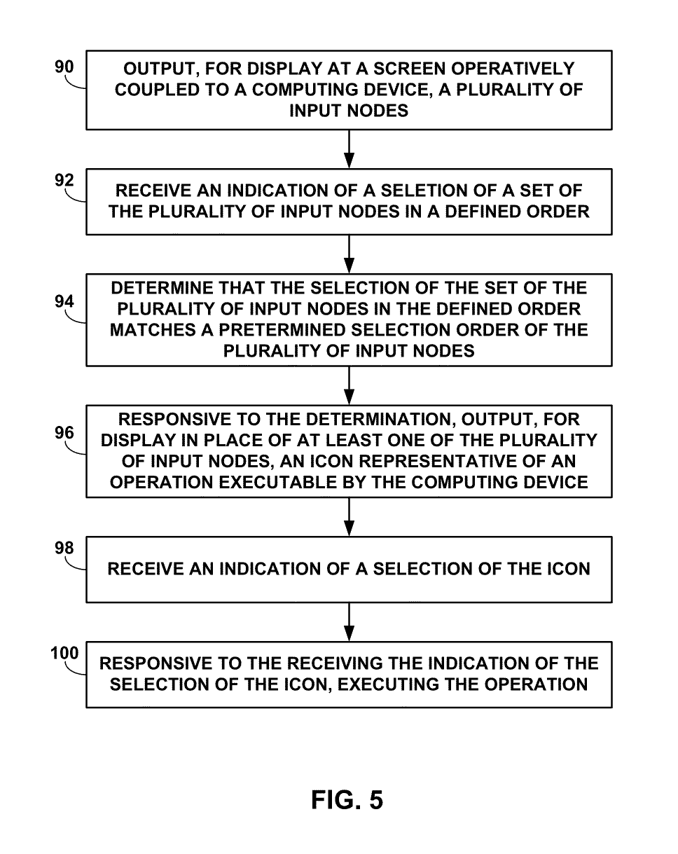

FIG. 5 is a flow diagram illustrating another example operation of computing device 50 that is configured to output icons representative of operations executable by computing device 50 in place of input nodes of a lock screen. For purposes of illustration only, computing device 50 of FIGS. 3A, 3B, and 4C will be described for the process of FIG. 5. Since computing device 50 may be an example of computing device 14, computing device 50 will be described as including processor 30 of FIG. 2.

As shown in the example of FIG. 5, when computing device 50 is in a locked state, processor 30 may be configured to output, for display at a presence-sensitive screen (e.g., a screen of user interface 16) operatively coupled to computing device 50, a plurality of input nodes 54 (of FIGS. 3A and 3B) (90). Processor 30 may be configured to receive an indication of a selection of a set of the plurality of input nodes 18 in a defined order (92). Processor 30 may be configured to then determine that the selection of the set of the plurality of input nodes 18 in the defined order matches a predetermined selection order of the plurality of input nodes (94). The predetermined selection and order may be associated with computing device 50.

Responsive to the determining, processor 30 may be configured to output, for display at the presence-sensitive screen in place of at least one of the plurality of input nodes 18, an icon (e.g., one of icons 62 of FIG. 3C) representative of an operation executable by computing device 50 (96). Processor 30 may be configured to then receive an indication of a selection of the icon (98). Responsive to receiving the indication of the selection of the icon, processor 30, for example, may be configured to execute the operation (100).

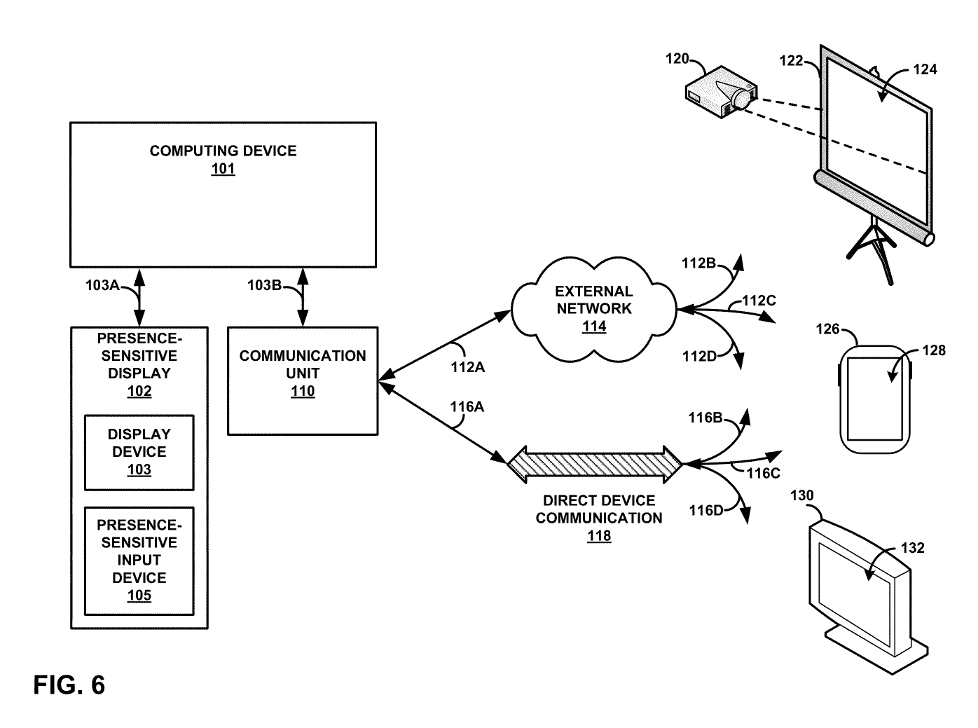

FIG. 6 is a block diagram illustrating an example computing device that outputs graphical content for display at a remote device, in accordance with one or more techniques of the present disclosure. Graphical content, generally, may include any visual information that may be output for display, such as text, images, a group of moving images, etc. The example shown in FIG. 6 includes a computing device 101, presence-sensitive display 102, communication unit 110, projector 120, projector screen 122, tablet device 126, and visual display device 130. Although shown for purposes of example in FIGS. 1 and 2 as a stand-alone computing device 14, a computing device may, generally, be any component or system that includes a processor or other suitable computing environment for executing software instructions and, for example, need not include a presence-sensitive display.

As shown in the example of FIG. 6, computing device 101 may be a processor that includes functionality as described with respect to processor 30 in FIG. 2. In such examples, computing device 101 may be operatively coupled to presence-sensitive display 102 by a communication channel 103A, which may be a system bus or other suitable connection. Computing device 101 may also be operatively coupled to communication unit 110, further described below, by a communication channel 103B, which may also be a system bus or other suitable connection. Although shown separately as an example in FIG. 6, computing device 101 may be operatively coupled to presence-sensitive display 102 and communication unit 110 by any number of one or more communication channels.

In other examples, such as illustrated previously in FIGS. 1-2 with regard to computing device 14, computing device 101 may be configured as a portable or mobile device such as mobile phones (including smart phones), laptop computers, etc. In some examples, computing device 101 may be a desktop computers, tablet computers, smart television platforms, cameras, personal digital assistants (PDAs), servers, mainframes, etc.

Presence-sensitive display 102, as shown in FIG. 6, may include display device 103 and presence-sensitive input device 105. Display device 103 may, for example, receive data from computing device 101 and display the graphical content. In some examples, presence-sensitive input device 105 may determine one or more user inputs (e.g., continuous gestures, multi-touch gestures, single-touch gestures, etc.) at presence-sensitive display 102 using capacitive, inductive, and/or optical recognition techniques and send indications of such user input to computing device 101 using communication channel 103A. In some examples, presence-sensitive input device 105 may be physically positioned on top of display device 103 such that, when a user positions an input unit over a graphical element displayed by display device 103, the location at which presence-sensitive input device 105 corresponds to the location of display device 103 at which the graphical element is displayed.

As shown in FIG. 6, computing device 101 may also include and/or be operatively coupled with communication unit 110. Communication unit 110 may include functionality of communication unit 32 as described in FIG. 2. Examples of communication unit 110 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 101 may also include and/or be operatively coupled with one or more other devices, e.g., input devices, output devices, memory, storage devices, etc. that are not shown in FIG. 6 for purposes of brevity and illustration.

FIG. 6 also illustrates a projector 120 and projector screen 122. Other such examples of projection devices may include electronic whiteboards, holographic display devices, and any other suitable devices for displaying graphical content. Projector 120 and project screen 122 may include one or more communication units that enable the respective devices to communicate with computing device 101. In some examples, the one or more communication units may enable communication between projector 120 and projector screen 122. Projector 120 may receive data from computing device 101 that includes graphical content. Projector 120, in response to receiving the data, may project the graphical content onto projector screen 122. In some examples, projector 120 may determine one or more user inputs (e.g., continuous gestures, multi-touch gestures, single-touch gestures, etc.) at projector screen using optical recognition or other suitable techniques and send indications of such user input using one or more communication units to computing device 101.

Projector screen 122, in some examples, may include a presence-sensitive display 124. Presence-sensitive display 124 may include a subset of functionality or all of the functionality of UI device 4 as described in this disclosure. In some examples, presence-sensitive display 124 may include additional functionality. Projector screen 122 (e.g., an electronic whiteboard), may receive data from computing device 101 and display the graphical content. In some examples, presence-sensitive display 124 may determine one or more user inputs (e.g., continuous gestures, multi-touch gestures, single-touch gestures, etc.) at projector screen 122 using capacitive, inductive, and/or optical recognition techniques and send indications of such user input using one or more communication units to computing device 101.

FIG. 6 also illustrates tablet device 126 and visual display device 130. Tablet device 126 and visual display device 130 may each include computing and connectivity capabilities. Examples of tablet device 126 may include e-reader devices, convertible notebook devices, hybrid slate devices, etc. Examples of visual display device 130 may include televisions, computer monitors, etc. As shown in FIG. 6, tablet device 126 may include a presence-sensitive display 128. Visual display device 130 may include a presence-sensitive display 132. Presence-sensitive displays 128, 132 may include a subset of functionality or all of the functionality of UI device 4 as described in this disclosure. In some examples, presence-sensitive displays 128, 132 may include additional functionality. In any case, presence-sensitive display 132, for example, may receive data from computing device 101 and display the graphical content. In some examples, presence-sensitive display 132 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 101.

As described above, in some examples, computing device 101 may output graphical content for display at presence-sensitive display 102 that is coupled to computing device 101 by a system bus or other suitable communication channel. Computing device 101 may also output graphical content for display at one or more remote devices, such as projector 120, projector screen 122, tablet device 126, and visual display device 130. For instance, computing device 101 may execute one or more instructions to generate and/or modify graphical content in accordance with techniques of the present disclosure. Computing device 101 may output the data that includes the graphical content to a communication unit of computing device 101, such as communication unit 110. Communication unit 110 may send the data to one or more of the remote devices, such as projector 120, projector screen 122, tablet device 126, and/or visual display device 130. In this way, computing device 101 may output the graphical content for display at one or more of the remote devices. In some examples, one or more of the remote devices may output the graphical content at a presence-sensitive display that is included in and/or operatively coupled to the respective remote devices.

In some examples, computing device 101 may not output graphical content at presence-sensitive display 102 that is operatively coupled to computing device 101. In other examples, computing device 101 may output graphical content for display at both a presence-sensitive display 102 that is coupled to computing device 101 by communication channel 103A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 101 and output for display at presence-sensitive display 102 may be different than graphical content display output for display at one or more remote devices.

Computing device 101 may send and receive data using any suitable communication techniques. For example, computing device 101 may be operatively coupled to external network 114 using network link 112A. Each of the remote devices illustrated in FIG. 6 may be operatively coupled to network external network 114 by one of respective network links 112B, 112C, and 112D. External network 114 may include network hubs, network switches, network routers, etc., that are operatively inter-coupled thereby providing for the exchange of information between computing device 101 and the remote devices illustrated in FIG. 6. In some examples, network links 112A-112D may be Ethernet, ATM or other network connections. Such connections may be wireless and/or wired connections.

In some examples, computing device 101 may be operatively coupled to one or more of the remote devices included in FIG. 6 using direct device communication 118. Direct device communication 118 may include communications through which computing device 101 sends and receives data directly with a remote device, using wired or wireless communication. That is, in some examples of direct device communication 118, data sent by computing device 101 may not be forwarded by one or more additional devices before being received at the remote device, and vice-versa. Examples of direct device communication 118 may include Bluetooth, Near-Field Communication, Universal Serial Bus, WiFi, infrared, etc. One or more of the remote devices illustrated in FIG. 6 may be operatively coupled with computing device 101 by communication links 116A-116D. In some examples, communication links 112A-112D may be connections using Bluetooth, Near-Field Communication, Universal Serial Bus, infrared, etc. Such connections may be wireless and/or wired connections.

In accordance with the techniques, devices, and systems of this disclosure, computing device 101 may be operatively coupled to visual display device 130 using external network 114 in some examples. In one example, computing device 101 may be configured to output, while computing device 101 is in a locked state and for display at presence-sensitive display 132, a plurality of input nodes. For instance, computing device 101 may send data that includes a representation of the plurality of input nodes to communication unit 110. Communication unit 110 may send the data that includes the representation of the plurality of input nodes to visual display device 130 using external network 114. Visual display device 130, in response to receiving the data using external network 114, may cause presence-sensitive display 132 to output the plurality of input nodes. In response to a user performing a gesture at presence-sensitive display 132 to select a set of the plurality of input nodes in a defined order, visual display device 130 may send an indication of the selection of the set of the plurality of input nodes in the defined order to computing device 101 via external network 114. Communication unit 110 may receive the indication of the selection, and send the indication to computing device 101.

Computing device 101 may be configured to determine that the selection of the set of the plurality of input nodes in the defined order matches a predetermined selection order of the plurality of input nodes, where the predetermined selection order is associated with computing device 101. Responsive to the determination, computing device 101 may output, for display in place of at least one of the plurality of input nodes at presence-sensitive screen 132, an icon representative of an operation executable by computing device 101. Similar to the plurality of input nodes, computing device 101 may transmit the icon to display device 130. Presence-sensitive screen 132 may generate an indication of a selection of the icon in response to a user provided gesture to presence-sensitive screen 132, and display device 130 may transmit the indication of the selection of the icon to computing device 101 such that computing device 101 may receive the indication of the selection of the icon. Responsive to receiving the indication of the selection of the icon, computing device 101 may be configured to execute the operation represented by the icon. In this fashion, computing device 101 may use any of the devices and communication protocols of FIG. 6 to implement any of the techniques described herein.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

In some examples, any of the described software units, modules or components may be executed as one or more distributed processes on one or more computing devices of a distributed system. In this way, workloads of any of the described software units, modules or components may be distributed across the distributed system for processing. In one example, a distributed system may include multiple autonomous computers that communicate through one or more communication channels, such as a computer network, to perform techniques implemented by the software units, modules or components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include, for example, random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, and optical media. In some examples, an article of manufacture may include one or more computer-readable storage media or tangible computer readable media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
while a computing device is in a locked state, outputting, by the computing device and for display, a plurality of input nodes at respective locations, wherein each of the plurality of input nodes is a graphical element;
receiving, by the computing device, an indication of a selection of a set of the plurality of input nodes in an order;
determining, by the computing device, that the selection of the set of the plurality of input nodes in the order matches a predetermined selection order of the plurality of input nodes, the predetermined selection order being associated with the computing device;
responsive to the determining, outputting, by the computing device and for display in place of at least one of the plurality of input nodes and at a respective location of the at least one of the plurality of input nodes, an icon representative of an operation executable by the computing device;
receiving, by the computing device, an indication of a selection of the icon; and
responsive to receiving the indication of the selection of the icon, executing, by the computing device, the operation.

2. The method of claim 1, wherein the selection of the set of the plurality of input nodes in the order comprises an input pattern.

3. The method of claim 2, wherein a predetermined set and order of the plurality of input nodes comprise a pattern key.

4. The method of claim 1, wherein receiving the indication of the selection of a set of the plurality of input nodes further comprises receiving a plurality of indications, each indication representative of a selection of each respective input node of the set.

5. The method of claim 1, wherein receiving the indication of the selection of the set of the plurality of input nodes further comprises receiving an indication of a continuous selection input that coincides with each of the input nodes in the set of the plurality of input nodes according to the order.

6. The method of claim 5, wherein the continuous selection input comprises the selection of the icon.

7. The method of claim 6, wherein determining that the selection of the set of the plurality of input nodes in the order matches the predetermined selection order of the plurality of input nodes comprises determining, during the continuous selection input, that the selection of the set of the plurality of input nodes in the order matches the predetermined selection order of the plurality of input nodes, and wherein the method further comprises:
responsive to the determining during the continuous selection input, outputting, by the computing device and for display in place of the at least one plurality of input nodes, the icon.

8. The method of claim 1, wherein receiving the indication of the selection of the set of the plurality of input nodes further comprises receiving an indication of a plurality of non-contiguous selections of the input nodes of the set.

9. The method of claim 1, further comprising, responsive to the determining, outputting, by the computing device and for display in place of each of two or more of the plurality of input nodes and at respective locations of the two or more of the plurality of input nodes, a respective icon representative of a respective operation executable by the computing device.

10. The method of claim 9, further comprising, responsive to the determining, outputting, by the computing device and for display in place of each of the plurality of input nodes and at each of the respective locations of the plurality of input nodes, a respective icon representative of a respective operation executable by the computing device.

11. The method of claim 9, further comprising:
prioritizing a plurality of operations executable by the computing device based on a frequency with which each of the plurality of operations have been previously executed by the computing device;
determining a last input node of the order; and
outputting, based on the prioritizing and for display in place of the plurality of input nodes, icons representative of more frequently executed operations in closer proximity to the last input node than icons representative of less frequently executed operations.

12. The method of claim 1, wherein the operation comprises at least one of launching an application, configuring a setting of the computing device, transmitting data from the computing device to a remote computing device, and establishing a communication channel between the computing device and the remote computing device.

13. The method of claim 1, further comprising, responsive to the determining, configuring the computing device in an unlocked state.

14. The method of claim 1, wherein the computing device is a mobile computing device.

15. A computer-readable storage device storing instructions that, when executed, cause one or more processors of a mobile computing device to perform operations comprising:
while the mobile computing device is in a locked state, outputting, by the mobile computing device and for display, a plurality of input nodes at respective locations, wherein each of the plurality of input nodes is a graphical element;
receiving an indication of a selection of a set of the plurality of input nodes in an order;
determining that the selection of the set of the plurality of input nodes in the order matches a predetermined selection order of the plurality of input nodes, the predetermined selection order being associated with the mobile computing device;
responsive to the determining, outputting, by the computing device and for display in place of each of two or more of the plurality of input nodes and at respective locations of the two or more of the plurality of input nodes, a respective icon representative of a respective operation executable by the mobile computing device;
receiving an indication of a selection of one of the respective icons; and
responsive to receiving the indication of the selection of the respective icon, executing the operation.

16. The computer-readable storage device of claim 15, wherein the stored instructions that, when executed, cause the one or more processors of the mobile computing device to perform operations comprising receiving the indication of the selection of the set of the plurality of input nodes further comprise instructions that, when executed, cause the one or more processors to perform operations comprising receiving an indication of a continuous selection input that coincides with each of the input nodes in the set of the plurality of input nodes according to the order, wherein the continuous selection input comprises the selection of the icon.

17. (canceled)

18. A mobile computing device comprising:
a user interface configured to display, while the mobile computing device is in a locked state, a plurality of input nodes at respective locations and receive a continuous selection input of a set of the plurality of input nodes, the continuous selection input identifying an order of the set of input nodes, wherein each of the plurality of input nodes is a graphical element; and
one or more processors configured to determine that the continuous selection input of the set of the plurality of input nodes and the order of the continuous selection input matches a predetermined set and order of the plurality of input nodes, the predetermined set and order being associated with the mobile computing device, wherein:
the user interface is further configured to, responsive to the determination, display, in place of at least one of the plurality of input nodes and at a respective location of the at least one of the plurality of input nodes, an icon representative of an operation executable by the one or more processors and receive a selection of the icon; and
the one or more processors are further configured to, responsive to the selection of the icon received by the user interface, execute the operation.

19. The mobile computing device of claim 18, wherein the continuous selection input comprises the selection of the icon.

20. The mobile computing device of claim 18, wherein the user interface is further configured to:
responsive to the determination, display, in place of each of two or more of the plurality of input nodes and at respective locations of the two or more of the plurality of input nodes, a respective icon representative of a respective operation executable by the one or more processors; and
receive a selection of once of the respective icons.

21. The computer-readable storage device of claim 15, further storing instructions that, when executed, cause the one or more processors of the mobile computing device to perform operations comprising:
prioritizing a plurality of operations executable by the computing device based on a frequency with which each of the plurality of operations have been previously executed by the mobile computing device;
determining a last input node of the order; and
outputting, based on the prioritizing and for display in place of the plurality of input nodes, icons representative of more frequently executed operations in closer proximity to the last input node than icons representative of less frequently executed operations.
